(19) United States
(12) Patent Application Publication
(10) Pub. No.: US 2022/0207294 A1
(43) Pub. Date: Jun. 30, 2022

(54) METHOD AND DEVICE FOR AUGMENTING TRAINING DATA BY COMBINING OBJECT AND BACKGROUND

(71) Applicant: Markany Inc., Seoul (KR)

(72) Inventors: So Won KIM, Seoul (KR); Sae Yun JEON, Seoul (KR); Seung Yeob CHAE, Seoul (KR)

(21) Appl. No.: 17/137,178

(22) Filed: Dec. 29, 2020

(30) Foreign Application Priority Data
Dec. 28, 2020 (KR) 10-2020-0185353
Dec. 28, 2020 (KR) 10-2020-0185355

(51) Int. Cl. G06K 9/62; G06T 11/60; G06K 9/00; G06N 3/08

(52) U.S. Cl. CPC G06K 9/6256; G06T 11/60; G06K 9/6267; G06K 2209/23; G06K 9/6288; G06K 9/6202; G06N 3/08; G06K 9/00362

(57) ABSTRACT

Disclosed a method for augmenting training data by combining an object and a background with each other. The method includes extracting an object image, wherein the object image is a machine learning target; determining a type of the object image; receiving a background image, wherein the background image comprises a plurality of different background regions; identifying a first background region and a second background region among the plurality of different background regions; and combining the object image with the first background region and the second background region to augment training data, wherein combining the object image with the first background region and the second background region includes randomly positioning an image of a first type object corresponding to the first background region into the first background region, and randomly positioning an image of a second type object corresponding to the second background region into the second background region.

### CROSS-REFERENCE TO RELATED APPLICATIONS

This application claims the benefit of priorities of Korean Patent Application No. 10-2020-0185353 filed on Dec. 28, 2020 and Korean Patent Application No. 10-2020-0185355 filed on Dec. 28, 2020, all of which are incorporated by reference in their entirety herein.

### BACKGROUND OF THE DISCLOSURE

### Field of the Disclosure

The present disclosure relates to a training data augmentation method, and a method for efficiently combining an object and a background with each other for training data generation.

### Related Art

Machine learning refers to a methodology for training a computer using data. Machine learning may be broadly classified into supervised learning, non-supervised learning, and reinforcement training. The supervised learning refers to a methodology for training a computer while a label (an explicit answer) to data is provided.

Typically, a machine learning model has more reliable performance as the model is trained with a large amount of data. Further, a convolutional neural network (CNN) as one of the machine learning models exhibits excellent performance in an image detection field. Since CNN has hundreds of thousands of parameters, the CNN must be trained with a sufficient number of machine learning target images. Therefore, in an object detection artificial neural network that detects an object from an image, in order to increase performance thereof, a method for learning a larger amount of data or improving the artificial neural network is required.

In a conventional training data construction process, a method for collecting related data, removing data that interfere with or is unnecessary in training, and labeling all objects to enable training is used.

FIG. 1 is a conceptual diagram for describing a conventional training data augmentation method.

Referring to FIG. 1, a process of constructing training data may include collecting related data for object extraction, removing unnecessary data that interferes with training, and a labeling process in which all objects are marked in an answer file to enable training. The process of constructing the training data in this way takes a lot of time and manpower.

More specifically, the training data may be augmented by cutting out an answer object and combining the cut object with another background. In particular, a process of marking a location and a region of an object so that a computer may identify the object (for example, a person) to be learned from an image may be referred to as labeling. When the training data is constructed in this way, the object is labeled so that it is easy to cut out the object. When combining the cut object with another background, labeling is not performed in a separate manner since the location of the object is already known during the combination process.

Further, in a method for augmentation of training data, when a background image is combined with an object, processing such as inverting a background image, rendering the background image in a black and white manner, or rotating the background image may occur. Thus, a plurality of augmented training data may be generated from a single background image. Further, processing such as inverting an object image, rendering the object image in a black and white manner, or rotating the object image may occur, or scaling, flipping, perspective transforming, and lighting conditioning of the object image may occur. In this way, the training data may be augmented. Additionally, randomly positioning one or more answer objects in the background image may allow a plurality of augmented training data to be generated.

However, the training data augmented in this way may have inconsistency because a relationship between the object and the background is not considered in the augmentation process, thereby causing decrease in performance of the machine learning. Further, repetitive use of the background image may cause an overfitting problem in an artificial neural network learning process.

### SUMMARY OF THE DISCLOSURE

A purpose of the present disclosure is to provide an object-background combination method in which training data is augmented by combining an object and a background in reality while a background region into which the object is positioned is specified based on the object.

A first aspect of the present disclosure provides a method for augmenting training data by combining an object and a background with each other, wherein the method is performed by a training data augmentation device, wherein the method comprises: extracting an object image, wherein the object image is a machine learning target; determining a type of the object image; receiving a background image, wherein the background image contains a plurality of different background regions; identifying a first background region and a second background region among the plurality of different background regions; and combining the object image with the first background region and the second background region to augment training data, wherein combining the object image with the first background region and the second background region includes randomly positioning an image of a first type object corresponding to the first background region into the first background region, and randomly positioning an image of a second type object corresponding to the second background region into the second background region.

In one implementation of the first aspect, the first background region includes a sidewalk region on which a person walks, wherein the first type object includes a person type object.

In one implementation of the first aspect, the second background region includes a road region on which the vehicle travels, wherein the second type object includes a vehicle type object.

In one implementation of the first aspect, randomly positioning the first type object includes spatially-randomly positioning at least one first type object into the first background region, and randomly positioning the second type object includes spatially-randomly positioning at least one second type object into the second background region.

In one implementation of the first aspect, the spatially-randomly positioning allows a plurality of different training data to be generated using a single background image.

In one implementation of the first aspect, the method further comprises: identifying a third background region among the plurality of different background regions, wherein an object is not able to be positioned into the third background region; and filling the third background region with noise.

In one implementation of the first aspect, a correspondence between the first background region and the first type object and a correspondence between the second background region and the second type object are pre-stored.

In one implementation of the first aspect, a category defining a type of the object image belongs to a first tree structure, and a background region corresponding to each type of the object image belongs to a second tree structure, wherein the first tree structure and the second tree structure are correlated with each other, wherein the first background region corresponding to the first type object and the second background region corresponding to the second type object are determined based on the correlation.

A second aspect of the present disclosure provides a device for augmenting training data by combining an object and a background with each other, the device comprising: an object extraction unit configured to extract an object image, wherein the object image is a machine learning target; an object category determination unit configured to determine a type of the object image; a background image receiving unit configured to receive a background image, wherein the background image contains a plurality of different background regions; an object-positioned region specifying unit configured to specify a first background region and a second background region among the plurality of different background regions; and an object-background combination unit configured to combine the object image with the first background region and the second background region to augment training data, wherein the object-background combination unit is further configured to randomly position an image of a first type object corresponding to the first background region into the first background region, and to randomly position an image of a second type object corresponding to the second background region into the second background region.

A third aspect of the present disclosure provides a method for augmenting training data by combining an object and a background with each other, wherein the method is performed by a training data augmentation device, wherein the method comprises: extracting an object image as a machine learning target; receiving a background image for training data augmentation; specifying an object-positioned region corresponding to the extracted object image in the background image based on an object-background matching policy; and randomly positioning the extracted object image into the specified object-positioned region.

In one implementation of the third aspect, the object image is categorized, wherein the object-background matching policy includes feature information on an image of an object-positioned region corresponding to a category of the object image, wherein the method further comprises extracting the object-positioned region corresponding to the category of the object image from the background image, based on the feature information.

In one implementation of the third aspect, the object-background matching policy includes first and second tree structures, wherein a category defining a type of an object image belongs to the first tree structure, and an object-positioned region corresponding to an object image belongs to the second tree structure, wherein the object-background matching policy includes correlation between the first tree structure and the second tree structure, wherein the object-positioned region corresponding to the object image is specified based on the correlation.

In one implementation of the third aspect, the method further comprises determining a category of an object image as a category of the lowest level in the first tree structure matching the object image.

In one implementation of the third aspect, the object-background matching policy defines a random positioned probability indicating how densely a specific object image is able to be distributed in a specific object-positioned region, wherein the specific object image is randomly positioned into the specified object-positioned region based on the random positioned probability.

A fourth aspect of the present disclosure provides a device for augmenting training data by combining an object and a background with each other, the device comprising: an object extraction unit configured to extract an object image as a machine learning target; a background image receiving unit configured to receive a background image for training data augmentation; an object-positioned region specifying unit configured to specify an object-positioned region corresponding to the extracted object image in the background image based on an object-background matching policy; and an object-background combination unit configured to randomly position the extracted object image into the specified object-positioned region.

A fifth aspect of the present disclosure provides a training data augmentation method using noise, wherein the method is performed by a training data augmentation device, wherein the method comprises: extracting an object image as a machine learning target; receiving a background image with which the extracted object image is to be combined; specifying at least a partial region of the background image as an object-excluded region; filling the object-excluded region with noise; and randomly positioning the object image into at least a partial region of the background image other than the object-excluded region.

In one implementation of the fifth aspect, the noise may be AWGN (Additive White Gaussian Noise).

In one implementation of the fifth aspect, the object-excluded region may be formed by excluding an available object-positioned region corresponding to the extracted object image from the background image.

In one implementation of the fifth aspect, the object image may be categorized, wherein the object-positioned region may be determined in a corresponding manner to a category of the extracted object image, and the object-excluded region may be calculated depending on the determination result of the object-positioned region.

In one implementation of the fifth aspect, the background image may include a plurality of available object-positioned regions, and an image of a first type object may be randomly positioned in a first available object-positioned region, and an image of a second type object may be randomly positioned in a second available object-positioned region.

In one implementation of the fifth aspect, in a first augmented training data, a region other than the first available object-positioned region and the second available object-positioned region in the background image may be designated as the object-excluded region which may be filled with noise, wherein in a second the augmented training data, a region other than only the first available object-positioned region in the background image may be designated as the object-excluded region which may be filled with noise.

In one implementation of the fifth aspect, filling the object-excluded region with noise may include filling an entirety of a region except for a region in which the object image is positioned in the background image with noise.

A sixth aspect of the present disclosure provides a training data augmentation device using noise, wherein the device comprises an object extraction unit configured to extract an object image as a machine learning target; a background image receiving unit configured to receive a background image with which the extracted object image is to be combined; an object-excluded region specifying unit configured to specify at least a partial region of the background image as an object-excluded region; and an object-background combination unit configured to fill the object-excluded region with noise and to randomly position the object image into at least a partial region of the background image other than the object-excluded region.

A seventh aspect of the present disclosure provides a training data augmentation method using noise, wherein the method is performed by a training data augmentation device, wherein the method comprises: extracting an object image as a machine learning target; receiving a background image with which the extracted object image is to be combined, wherein the background image includes an image entirely filled with noise; and randomly positioning the object image into the background image.

An eighth aspect of the present disclosure provides a training data augmentation device using noise, wherein the training data augmentation device comprises: an object extraction unit configured to extract an object image as a machine learning target; a background image receiving unit configured to receive a background image with which the extracted object image is to be combined, wherein the background image includes an image entirely filled with noise; and an object-background combination unit configured to randomly position the object image into the background image.

### BRIEF DESCRIPTION OF THE DRAWINGS

FIG. 1 is a conceptual diagram for describing a conventional training data augmentation method.

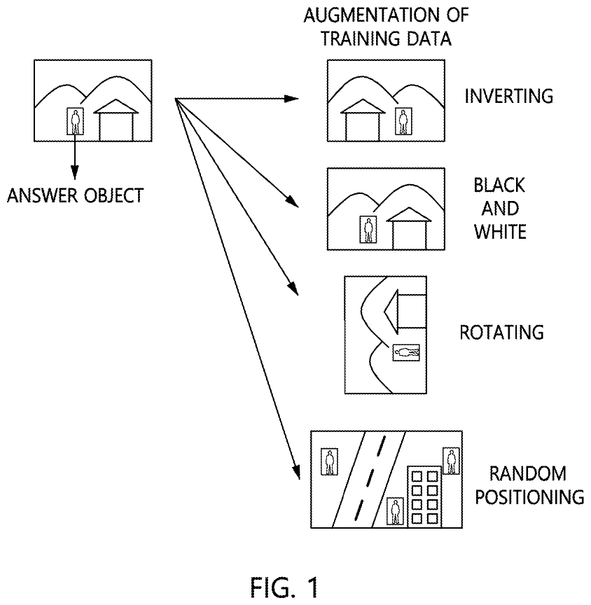

FIG. 2 is a flow chart showing a method for augmenting training data by combining an object and a background with each other according to an embodiment of the present disclosure.

FIG. 3 is a conceptual diagram to describe a method for specifying a background region corresponding to an object, and combining the object and the background region corresponding to the object with each other.

FIG. 4 is an example diagram showing an image of training data augmented by combining an object with a background image according to the method in FIG. 3.

FIG. 5 is a detailed flow chart showing a process of filling an object-excluded region with noise except for an object-positioned region.

FIG. 6 shows an example diagram showing training data generated by filling a partial region of a background image with noise according to the method in FIG. 5, and positioning an object into another partial region thereof.

FIG. 7 is an example diagram showing a tree structure in which a person object is categorized.

FIG. 8 is an exemplary diagram showing a tree structure in which a vehicle object is a categorized.

FIG. 9 is a conceptual diagram for describing a process in which an object and background matching table manages a probability that a specific object will be positioned in a specific background region.

FIG. 10 is a block diagram showing a device for augmenting training data by combining an object and a background with each other according to an embodiment of the present disclosure.

### DETAILED DESCRIPTION OF EMBODIMENTS

For simplicity and clarity of illustration, elements in the figures are not necessarily drawn to scale. The same reference numbers in different figures denote the same or similar elements, and as such perform similar functionality. Moreover, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expressions such as “at least one of” when preceding a list of elements may modify the entire list of elements and may not modify the individual elements of the list.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

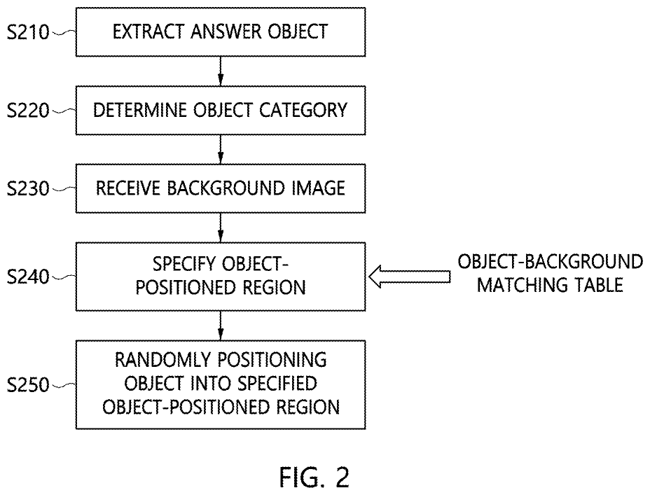

FIG. 2 is a flowchart showing a method for augmenting training data by combining an object and a background with each other according to an embodiment of the present disclosure.

Referring to FIG. 2, a device augmenting training data by combining an object and a background with each other according to an embodiment of the present disclosure extracts a answer object from a plurality of pre-stored images prepared for machine learning of an object detection algorithm (S210). The answer object refers to a detection target of a real object detection algorithm. This answer object may be implemented as various types of objects such as person objects, vehicle objects, and product objects. The answer object may be extracted from a plurality of pre-stored images via user selection. That is, the user extracts and registers an object to be learned from pre-stored images according to a purpose of image reading. When the object is extracted, information related to the object may be indicated (a kind of labeling) so that the information may be subsequently used for labeling when generating augmented training data using object positioning.

The device determines a category of the extracted answer object (S220). The device collects the extracted answer object to be combined with a background image. In this connection, it is desirable to clearly define a type of the extracted object in order to position the object in an appropriate region of the background image. When the extracted object is an object including a person's human body, this object may be clearly defined as a “person” type object, such that that the object may be positioned into a region of a background image corresponding thereto. The type of the object may be specified by the user directly.

Alternatively, in a pre-stored object-background matching policy (when this has a table form, the object-background matching policy may be referred to as “object-background matching table”), the device may directly specify the type of the object as one of predefined types with reference to the object-background matching table. When the device specifies the type of the object directly, the device analyzes features of the extracted objects and compares the features with features of objects of a predefined specific type and/or a specific category (the features may be defined using a number of parameters constituting the image).

The device may receive the background image with which the extracted object is to be combined (S230). The background image may be pre-stored in a memory in the device, or may be received from plurality of external devices connected to the device through a wired or wireless network.

After the background image is input to the device, the device specifies an available object-positioned region in which the object may be positioned within the input background image (S240). This operation is performed by using the object-background matching table with reference to a category of the answer object specified in the operation S220. The object-background matching table may be formed by matching a feature of a background region corresponding to an object belonging to a specific category with the object. A matching relationship may be established based on whether the object may be actually (realistically) present in the corresponding background region. The matching relationship may be pre-stored in the device's memory. Alternatively, the matching relationship may be set by the user directly specifying the background region.

For example, an object of the person category may be defined to be positioned in a background region such as “sidewalk, crosswalk, inside a building”. The device may parameterize and store therein an image feature of the defined background region. Accordingly, the device may determine whether the background region corresponding to the object category defined in the operation S220 is present in the background image input in operation S230. According to the determination result, the device may divide the input background image into one or more regions to specify a region in which the object is to be positioned. The object-background matching table defines an image feature of the background region matching with the object using a plurality of parameters related to the image. Thus, the device may extract the available object-positioned region from the background image using the parameters related to the background region defined in the table, and match the extracted available object-positioned region with the answer object, such that the corresponding object may be randomly positioned into the matched extracted available object-positioned region. In this connection, when there are a plurality of answer objects to be learned, a plurality of available object-positioned regions corresponding thereto may be specified in the background image. Conversely, when there is no available object-positioned region in the background image, the corresponding background image is ignored and another background image is input, and then the operation S240 is repeated.

After the available object-positioned region is specified in the background image, the object and background combination process is completed by randomly positioning the corresponding object into the specified object-positioned region (S250). The positioning of the object may include randomly positioning the object in the corresponding region regardless of a location and number of objects. The device performs labeling while randomly positioning the corresponding object in the specified object-positioned region. In other words, the device stores size information and location information about the object via the labeling, so that when a machine learning program analyzes the image, the program may learn which object is present at which location. In this connection, the category of the object may also be labeled. Codec and other state information may also be labeled. When the object is combined with the background, the object may be inverted, may be rendered in a black and white manner, and may be rotated, or may be subjected to scaling, flipping, perspective transforming, and lighting conditioning. Information on the above processing may be recorded in a label.

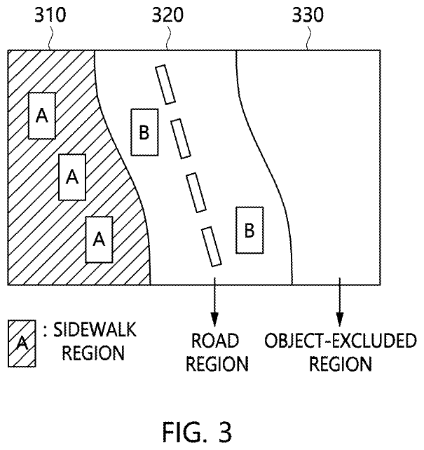

FIG. 3 is a conceptual diagram to describe a method to realistically combine an object with a background region corresponding to the object.

Referring to FIG. 3, when a background image is input, the device determines an available object-positioned region corresponding to an extracted object. When the device intends to achieve augmentation of training data for an object of a single type, it is only necessary to specify a background region corresponding to the object of the single type. When a device intends to achieve training data augmentation for objects of at least two types, it is desirable to specify a plurality of background regions in consideration of the objects of the at least two types.

In an embodiment of FIG. 3, when the device intends to generate augmented training data for an A-type object and a B-type object, the device may specify a region 310 as a background region corresponding to the A-type object, and a region 320 as a background region corresponding to the B-type object. In this connection, the A-type object may be a “person” object including a human body. The region 310 may be identified and specified as a sidewalk region along which a person may walk. The B-type object may be a “vehicle” object. The region 320 may be identified and specified as a road region along which a vehicle may drive.

The matching relationship between the A-type object and the image feature of the corresponding region 310 thereto, and the matching relationship between the B-type object and the image feature of the region 320 corresponding thereto may be defined based on the object-background matching table or the object-background matching policy. The device specifies a region in which the object is to be positioned in the background image, based on the defined relationship.

An object-excluded region 330 other than the region corresponding to the object in the background image may be automatically calculated after the available object-positioned regions 310 and 320 are specified. The device does not position the object in the object-excluded region 330. Rather, the device may randomly position the objects corresponding to the regions 310 and 320 into the regions 310 and 320 to generate a realistic machine learning target image. In the embodiment of FIG. 3, the device positions three A-type objects in the region 310 and two B-type objects in the region 320. In this connection, as described above, when positioning each of the objects, the device may label a type (one type includes plurality of hierarchical categories therein), a size, a location of each object, and other environmental information such that a learning program recognizes the labeled information.

In one example, a plurality of machine learning target images may be generated by varying the random positioning of the object on a single background image. For example, the A-type object may be positioned into the region 310 while varying a location and the number of the A-type objects or other parameters (inverting, rotation, scaling, etc.). Accordingly, two A-type objects may be positioned into the region 310 while five B-type objects may be positioned in the region 320. In this way, another machine learning target image may be generated. It is desirable for the device to generate as many machine learning target images as possible for one background image up to a predefined reference. Regarding the predefined reference, in an example, the device may set the number of times of augmentations based on a size and/or the number of the available object-positioned regions and then may perform augmentation of the machine learning target image until the numbers of augmentations reaches the set number of times.

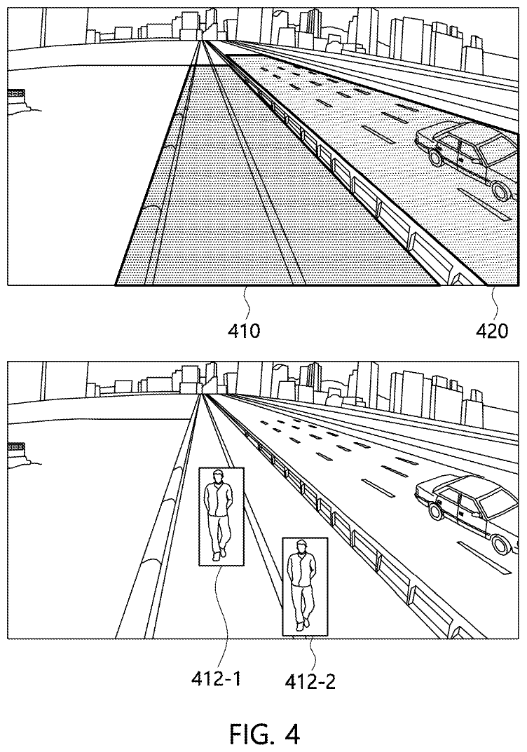

FIG. 4 is an exemplary diagram showing an image of training data augmented by combining an object with a background image according to the method in FIG. 3.

Referring to an upper drawing of FIG. 4, the device may divide a background image containing a sidewalk, a road, a river, and buildings into a plurality of regions and thus define available object-positioned regions, based on the division result. In an embodiment of FIG. 4, a region 410 may be defined as a sidewalk region on which a person travels, and a region 420 may be defined as a road region on which a vehicle travels, and other regions may be defined as the object-excluded region.

When the device detects the available object-positioned region, the device relies on the answer object. That is, a plurality of available object-positioned regions corresponding to the answer object may be defined. The device analyzes whether any one of the plurality of available object-positioned regions is present in the background image.

Referring to a lower drawing of FIG. 4, the device positions only person objects (412-1, 412-2) in the region 410, and positions only vehicle objects (not shown) in the region 420. In this manner, the augmented training data may be generated by combining the object and the background with each other more realistically.

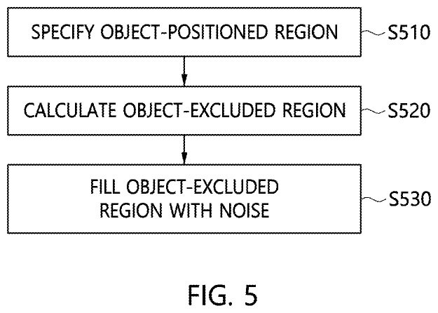

FIG. 5 is a detailed flow chart showing a process of filling the object-excluded region with noise except for the available object-positioned region.

Referring to FIG. 5, the device specifies the available object-positioned region according to the method of FIG. 2 (especially, operation S240) (S510). After one or more regions (available object-positioned regions) in which the object may be positioned are determined, the device may calculate a remaining region other than the determined region in the background image and may specify the remaining region as the object-excluded region (S520).

Then, the device may fill the object-excluded region with noise (S530). From a point of view of learning by the object detection algorithm, the object detection algorithm intends to receive a random value of the background and to accurately detect only the answer object. Therefore, the device may fill a region in which an object may not be positioned with noise, and thus may maximally randomizes the corresponding region, thereby achieving improvement of learning performance.

In one example, the noise is preferably white noise (AWGN: Additive White Gaussian Noise). Repetitive use of the background image may cause the overfitting problem in the artificial neural network learning process. Therefore, in the process of augmentation of training data by combining the object and the background with each other, the object-excluded region may be specified. Whenever the same background is reused, it is desirable to randomly fill the object-excluded region with the white noise to prevent the overfitting.

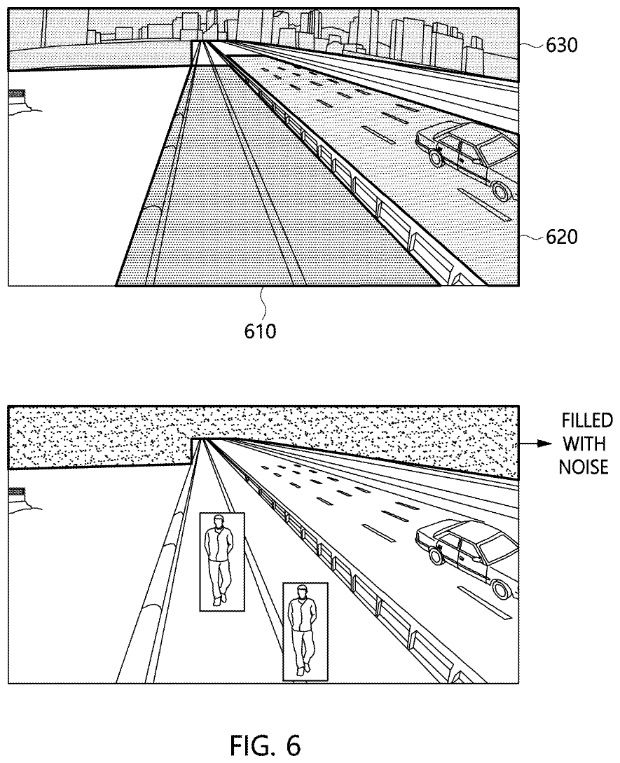

FIG. 6 shows an example diagram showing training data generated by filling a partial region of a background image with noise according to the method in FIG. 5, and positioning an object into another partial region thereof.

Referring to an upper drawing of FIG. 6, the region 610 and the region 620 may receive the person object and the vehicle object, respectively. The device may specify a region 630 except for these two regions 610 and 620 as the object-excluded region.

Then, as shown in a lower drawing of FIG. 6, the device may fill the corresponding region 630 with noise, and may randomly position objects in the two regions 610 and 620 to generate augmented training data.

In one example, the device may place noise in at least some of the available object-positioned regions in some cases. For example, when generating plurality of augmented training data using one background image, the objects corresponding to the regions 610 and 620 may be positioned into the regions 610 and 620, respectively. When at least a certain number of augmented training data have been generated, the region 620 may be set as an object-excluded region, and even the region 620 may be filled with noise, for generation of more diverse exemplary training data. Thus, the person object may be randomly positioned only in the region 610, and the regions 620 and 630 may be filled with noise. Alternatively, the vehicle object may be randomly positioned only in the region 620, and the regions 610 and 630 may be filled with noise. In this way, another augmented training data may be generated.

In another example, augmented training data may be generated by filling the entire background image with noise and then randomly positioning only objects therein. That is, all regions other than a region where the answer object is positioned may be filled with noise. In this embodiment, the training data may have the random number to a maximum degree.

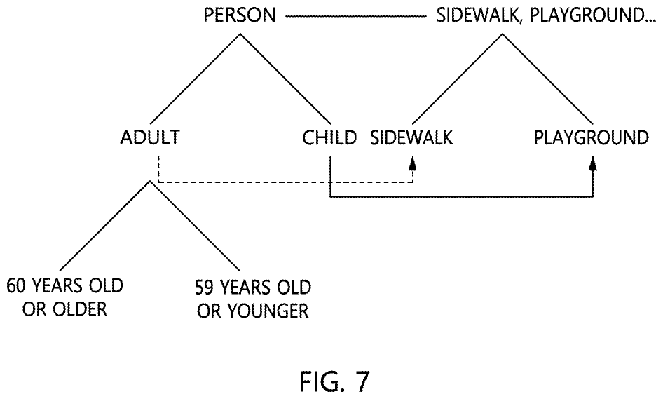

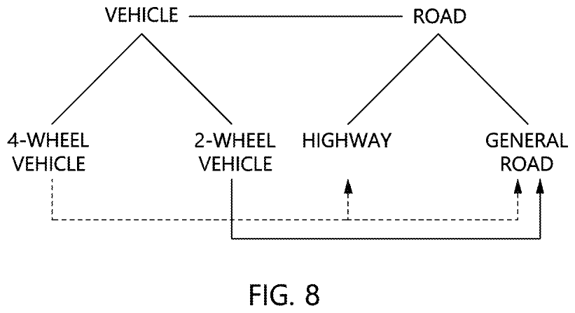

FIG. 7 is an example diagram showing a tree structure in which the person object is categorized. FIG. 8 is an exemplary diagram showing a tree structure in which a vehicle object is categorized.

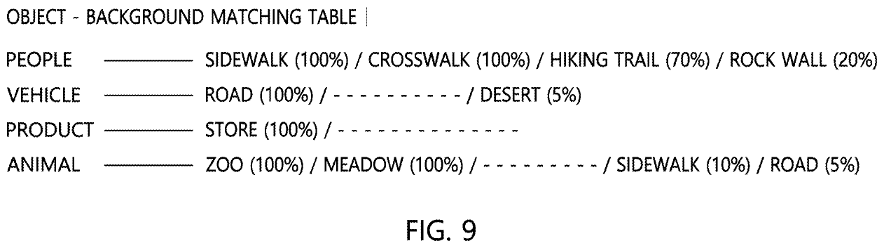

Referring to FIG. 7 and FIG. 8, the answer object may be categorized into one of several types of categories. A hierarchical categorization may form a tree structure. For the person object, a higher category “person” may be classified into two lower categories “adult” and “child”. The “adult” may be further classified into two lower categories “60 years old or older” and “59 years old or younger”. The “person” (A) object as the highest category may correspond to regions such as a sidewalk (A₁), a crosswalk (A₂), a playground (A₃), . . . etc. The lower category “child” (Aₐ) object may correspond to regions such as a playground (Aa₁), a kids cafe (Aa₂), etc. The lower “adult” (Ab) object may correspond not to regions such as a playground and a kids cafes but to regions such as a sidewalk (Ab₁), a crosswalk (Ab₂), and a golf course (Ab₃). In another example, the lower “adult” (Ab) object may correspond to the playground or the kids cafe. To this end, the user may set the matching relationship while considering this correspondence in the object-background matching table. In consideration of a distribution probability, different random variables may be allocated to the “child” object and the “adult” object, so that an appropriate object-background combination may be achieved (see FIG. 9).

In other words, a background region (Aaₙ region) corresponding to the Aa object as the lower category below the A category (person-related object) may include an entirety or a portion of the Aₙ region corresponding to the A category. That is, the background region corresponding to an object of a lower category may be included in a background region corresponding to an object of a higher category.

In an example of FIG. 8, the “vehicle” object as the highest category may correspond to a road region. In this connection, “4-wheel vehicle” as a lower category below the highest category “vehicle” may correspond to “highway” and “general road” while the other lower category “two-wheel vehicle” may not correspond to “highway” and may correspond only to the “normal road”. In this way, the category defining the type of the object forms a tree structure. The corresponding background region to the object also forms a tree structure. The two tree structures may have a correspondence relationship with each other. However, a category of a specific level in the object-related tree structure may not correspond to a background region of a specific level in the background region-related tree structure in a one-to-one manner. In other words, it is desirable that a background region corresponding to each category in the object-related tree structure is individually specified (defined) in the background region related tree structure.

FIG. 9 is a conceptual diagram for describing a process in which an object and background matching table manages a probability that a specific object will be positioned in a specific background region.

Referring to FIG. 9, the available object-positioned region for the person-related object may include sidewalks, crosswalks, hiking trails, and rock walls. The device may preset a random positioned probability (which may be referred to as a distribution probability or a distribution percentage) based on a probability of distribution of an object into a corresponding region thereto. Then, the device may control the object to be positioned into the region based on the preset probability. For example, when a probability that a person will be distributed on the sidewalk may be set to 100%, the person objects may be densely positioned on the sidewalk. The probability as used herein refers to a relative probability of distribution of an object into a corresponding region thereto, compared to a probability of distribution of the object into other background regions. Further, the distribution probability may be related to a positioned saturation. That is, 100% means that the object may be positioned in substantially an entirety of the corresponding region thereto. A probability that a person will be distributed on the hiking trail may be set to 70% which is lower than the probability 100% that a person will be distributed on the sidewalk. Thus, the random positioned saturation of the object in the corresponding region, that is, the hiking trail may be set to about 70%. A probability that a person will be distributed on the rock wall may be set to 20% which is lower than the probability of 70% that a person will be distributed on the hiking trail. Thus, the random positioned saturation of the object in the corresponding region, that is, the rock wall may be set to about 20%. In this connection, the probability of distribution for the lower category below the “person” category may vary. For the “adult” category, the wall rock region may have the same distribution percentage, that is, 20%, as the distribution percentage for the “person” category. However, for the “child” category, the rock wall region may be specified as an object-excluded region. That is, for the “child” category, the rock wall region may have a distribution percentage of 0%. Thus, the distribution percentage of the object into the region may vary based on a category level within the category tree structure. The object positioned distribution probability reflects reality and may be preset and managed in the object-background matching table

Regarding the vehicle type category, a road region may have a distribution percentage of 100%, a mountain region may have a distribution percentage of 10% and a desert region may have a distribution percentage of 5%.

Regarding the product type category, a product sales store shelf region may have a distribution percentage of 100%, a region within a building may have a distribution percentage of 70% and a human body may have a distribution percentage of 50%. In particular, the region may have the distribution percentage varying depending on a type of the product. Regarding a shoe object, a lower body region of a person may have a distribution percentage of 50%, and an upper body region of a person may have a distribution percentage of 0%.

Regarding an animal type category, each of a zoo region and a grassland region may have a distribution percentage of 100%, and each of a sidewalk region and a road region may have a distribution percentage of less than 10%.

In one background image, there may be a plurality of background regions corresponding to a single category. For example, when the device randomly positions an adult object in the background image where the playground and the sidewalk coexist, the adult object may be positioned in both the playground region and the sidewalk region while the adult object may be positioned in the playground region at 10% distribution percentage, and the adult object may be positioned in the sidewalk region at 100% distribution percentage. That is, a answer object may be randomly positioned in a plurality of regions within one background image at different distribution percentages according to the policy of the table.

When the device specifies the available object-positioned region for a specific object, and when there are a plurality of available object-positioned regions corresponding to the object, an object-positioned region having a higher distribution percentage may be prioritized. Thus, the object may be first positioned into the object-positioned region having a higher distribution percentage. For example, when specifying the available object-positioned region for the person object, the device may specify the sidewalk region and the crosswalk region having 100% distribution percentage as the object-positioned region having a first priority. Next, the device may specify the hiking trail and the rock wall as the object-positioned regions having a second priority and third priority, respectively. Then, the device may randomly position the object in the specified object-positioned region based on the priority according to the corresponding distribution percentage.

Further, different answer objects may be positioned in one object-positioned region. For example, a vehicle object may be positioned in a road region, while a person object may be positioned in the road region at a low distribution percentage (less than 10%). In this connection, it is desirable that a sum of the distribution percentages of the two answer objects in a single region in the random positioning of the two answer objects in the single region does not exceed a value of a higher distribution percentage among predefined distribution percentages of the two answer objects. In other words, it is desirable that when the vehicle is positioned in the road region at 90% distribution percentage and the person is positioned in the road region at 10% distribution percentage, a sum of the two distribution percentages does not exceed 100%.

In one example, according to another embodiment of the present disclosure, the device may generate a plurality of machine learning target images based on the distribution probability of the object-background matching table and combine the images with each other to generate new augmented training data. For example, the device may generate first to fourth machine learning target images, and may position the first to fourth machine learning target images such that the first machine learning target image is positioned in an upper left, the second machine learning target image is positioned in an upper right, the third machine learning target image is positioned in a lower left, and the fourth machine learning target image is positioned in a lower right. Thus, a fifth machine learning target image may be generated.

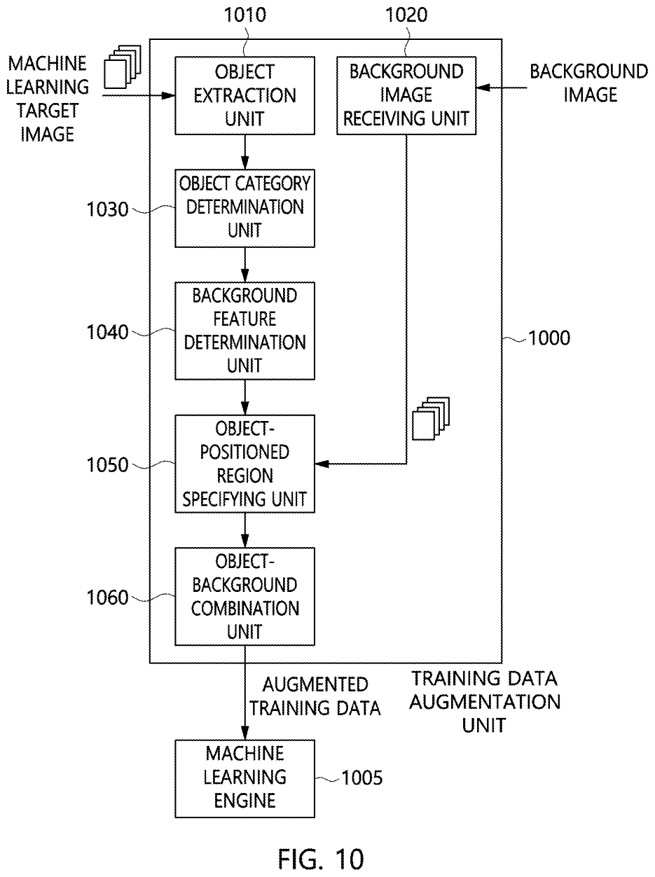

FIG. 10 is a block diagram showing a device for augmenting training data by combining an object and a background with each other according to an embodiment of the present disclosure.

As shown in FIG. 10, a training data augmentation device according to an embodiment of the present disclosure includes an object extraction unit 1010, a background image receiving unit 1020, an object category determination unit 1030, and a background feature determination unit 1040, an object-positioned region specifying unit 1050, and an object-background combination unit 1060.

Referring to FIG. 10, the training data augmentation device may include a training data augmentation unit 1000 and a machine learning engine 1005. In this connection, the training data augmentation unit 1000 may generate a plurality of augmented machine learning target images based on the answer object, and provide the plurality of augmented machine learning target images to the machine learning engine 1005. The training data augmentation unit 1000 may be implemented using a microprocessor, and may execute instructions stored in a memory (not shown). Hereinafter, individual components of the training data augmentation unit 1000 will be described in more detail.

The object extraction unit 1010 extracts a answer object from a plurality of pre-stored images prepared for machine learning of an object detection algorithm. The answer object may refer to an extraction target by an object detection algorithm, and may be extracted via user selection. In another example, the device may receive and obtain an already selected object image. When the object is extracted, the object's size information, codec information, and other environmental information (image generation date, source, etc.) may be labeled and prepared to be used for labeling when the object and background are combined with each other. There may be a plurality of answer objects.

The background image receiving unit 1020 receives arbitrary background images. The background images may be pre-stored in the device's memory, or may be received from other devices connected to the device through a network. In some cases, the background image may include an image entirely filled with noise.

The object category determination unit 1030 determines a category of the answer object extracted by the object extraction unit 1010. In order to combine the object with an appropriate region of the background image, and thus to clearly define a nature of the extracted object, the category of the extracted object is determined based on the object-background matching policy. When there are a plurality of objects, categories of the plurality of objects are determined. In this connection, since a category of a single type has a hierarchical structure, it may be very difficult to find a level in the hierarchical structure of the single category to which the object belongs. In this connection, as the object has a lower level category, information about the answer object may be more specific. Thus, it is preferable that the object category determination unit 1030 matches the answer object with the lowest level category. Thus, the reality of the training data is improved. For example, it is preferable that the object category determination unit 1030 may determine a category of an infant under an age of 3 as the category “infant” as the lowest level category among the three categories in the category hierarchy of “person-child-infant”. In this way, the object may correspond to the narrowest object-positioned region even in the tree structure of the object-positioned region, thereby achieving a more realistic combination.

The background feature determination unit 1040 determines a feature of a background region corresponding to a category determined by the object category determination unit 1030. The background feature determination unit 1040 may parameterize an image feature of the corresponding background region and store the parameterized image feature therein. Accordingly, the background feature determination unit 1040 fetches the parameters of the corresponding background region and provides the same to the object-positioned region specifying unit 1050.

The object-positioned region specifying unit 1050 may specify the object-positioned region in the background image received through the background image receiving unit 1020, based on the image-related feature parameters of the available object-positioned region provided from the background feature determination unit 1040. In this connection, when any available object-positioned region corresponding to the answer object is not detected in the background image, the corresponding background image is excluded from the training data.

The object-background combination unit 1060 may randomly position the answer object corresponding to the region specified by the object-positioned region specifying unit 1050 into the specified region to generate augmented training data. The object may be positioned randomly into the corresponding region while the number and a location of the objects are not limited. The object-background combination unit 1060 performs labeling while randomly positioning the corresponding object into the specified object-positioned region. The object-background combination unit 1060 may fill the object-excluded region other than the available object-positioned region in the background image with noise. In this connection, the noise may be set to AWGN, such that the object-excluded region may have the random number to a maximum degree.

The training data augmented by the training data augmentation unit 1000 may be provided to the machine learning engine 1005, so that a related object detection algorithm may be trained in the corresponding engine 1005. The machine learning engine 1005 may be executed in the device including the training data augmentation unit 1000 or may exist on another device.

The machine learning engine 1005 may additionally include a detection rate measurement module that measures the detection rate. Thus, the device may learn the identification of the object, the tree structure of the category, the matching relationship between the object and the background region, etc. by itself, based on the detection rate of the machine learning engine 1005 using the training data augmented according to an embodiment of the present disclosure. That is, the augmented machine learning target image and the detection rate information as used may be returned to the training data augmentation unit 1000. The training data augmentation unit 1000 may use the augmented machine learning target image and the detection rate information as training data for establishing the identification of the object, the tree structure of the category, the matching relationship between the object and the background region, etc. A training data set includes labeling information of the augmented training data as used (the information includes object identification information, category tree structure information, and information on the matching relationship between the object and the background region (including the distribution percentage)) and a detection rate value at which the machine learning engine 1005 detects the answer object, based on the labeling information. Then, in order to increase the detection rate, the device changes hyperparameters based on the training data set. The hyperparameter to be changed may be related to the identification of the answer object, the tree structure, and the matching relationship between the object and the background region. Accordingly, a setting value related to the hyperparameter may be determined as a parameter having the highest detection rate.

According to the method for augmenting the training data by combining the object and the background with each other according to the present disclosure, the training data may be augmented based on the relationship between the object and the background, such that the reality of the augmented training data is increased, thereby improving the performance of the deep learning engine.

Although the disclosure has been described above with reference to the drawings and the embodiments, a protection scope of the present disclosure is limited to the drawings or embodiments. Those skilled in the art of the present technical field will appreciate that the present disclosure may be variously modified and changed without departing from the spirit and the scope of the present disclosure as described in the following claims.

What is claimed is:

1. A method for augmenting training data by combining an object and a background with each other, wherein the method is performed by a training data augmentation device, wherein the method comprises:
extracting an object image, wherein the object image is a machine learning target;
determining a type of the object image;
receiving a background image, wherein the background image comprises a plurality of different background regions;
identifying a first background region and a second background region among the plurality of different background regions; and
combining the object image with the first background region and the second background region to augment training data,
wherein combining the object image with the first background region and the second background region includes randomly positioning an image of a first type object corresponding to the first background region into the first background region, and randomly positioning an image of a second type object corresponding to the second background region into the second background region.

2. The method of claim 1, wherein the first background region includes a sidewalk region on which a person walks,
wherein the first type object includes a person type object.

3. The method of claim 1, wherein the second background region includes a road region on which the vehicle travels,
wherein the second type object includes a vehicle type object.

4. The method of claim 1, wherein randomly positioning the first type object includes spatially-randomly positioning at least one first type object into the first background region, and randomly positioning the second type object includes spatially-randomly positioning at least one second type object into the second background region.

5. The method of claim 4, wherein the spatially-randomly positioning allows a plurality of different training data to be generated using a single background image.

6. The method of claim 1, wherein the method further comprises:
identifying a third background region among the plurality of different background regions, wherein an object is not able to be positioned into the third background region; and
filling the third background region with noise.

7. The method of claim 1, wherein a correspondence between the first background region and the first type object and a correspondence between the second background region and the second type object are pre-stored.

8. The method of claim 1, wherein a category defining a type of the object image belongs to a first tree structure, and a background region corresponding to each type of the object image belongs to a second tree structure,
wherein the first tree structure and the second tree structure are correlated with each other, and
wherein the first background region corresponding to the first type object and the second background region corresponding to the second type object are determined based on the correlation.

9. A device for augmenting training data by combining an object and a background with each other, the device comprising:
an object extraction unit configured to extract an object image, wherein the object image is a machine learning target;
an object category determination unit configured to determine a type of the object image;
a background image receiving unit configured to receive a background image, wherein the background image comprises a plurality of different background regions;
an object-positioned region specifying unit configured to specify a first background region and a second background region among the plurality of different background regions; and
an object-background combination unit configured to combine the object image with the first background region and the second background region to augment training data,
wherein the object-background combination unit is further configured to randomly position an image of a first type object corresponding to the first background region into the first background region, and to randomly position an image of a second type object corresponding to the second background region into the second background region.

10. A method for augmenting training data by combining an object and a background with each other, wherein the method is performed by a training data augmentation device, wherein the method comprises:
extracting an object image as a machine learning target;
receiving a background image for training data augmentation;
specifying an object-positioned region corresponding to the extracted object image in the background image based on an object-background matching policy; and
randomly positioning the extracted object image into the specified object-positioned region.

11. The method of claim 10, wherein the object image is categorized,
wherein the object-background matching policy includes feature information on an image of an object-positioned region corresponding to a category of the object image,
wherein the method further comprises extracting the object-positioned region corresponding to the category of the object image from the background image, based on the feature information.

12. The method of claim 10, wherein the object-background matching policy includes first and second tree structures, wherein a category defining a type of an object image belongs to the first tree structure, and an object-positioned region corresponding to an object image belongs to the second tree structure,
wherein the object-background matching policy includes correlation between the first tree structure and the second tree structure, and
wherein the object-positioned region corresponding to the object image is specified based on the correlation.

13. The method of claim 12, wherein the method further comprises determining a category of an object image as a category of the lowest level in the first tree structure matching the object image.

14. The method of claim 10, wherein the object-background matching policy defines a random positioned probability indicating how densely a specific object image is able to be distributed in a specific object-positioned region,
wherein the specific object image is randomly positioned into the specified object-positioned region based on the random positioned probability.

15. A device for augmenting training data by combining an object and a background with each other, the device comprising:
an object extraction unit configured to extract an object image as a machine learning target;
a background image receiving unit configured to receive a background image for training data augmentation;
an object-positioned region specifying unit configured to specify an object-positioned region corresponding to the extracted object image in the background image based on an object-background matching policy; and
an object-background combination unit configured to randomly position the extracted object image into the specified object-positioned region.
